(19) United States
(12) Patent Application Publication
(10) Pub. No.: US 2007/0271553 A1
(43) Pub. Date: Nov. 22, 2007

(54) Method and system for translating assembler code to a target language

(75) Inventors: Donald S. Higgins, Pinellas Park, FL (US); Robert Jones, Rockville, MD (US)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: Micro Focus (US), Inc., Rockville, MD (US)

(21) Appl. No.: 11/437,875

(22) Filed: May 22, 2006

(51) Int. Cl. G06F 9/45

(52) U.S. Cl. 717/136

(57) ABSTRACT

A method and system for translating assembler code to target high level language source code is disclosed, the method including generating base macro code, based on a plurality of base macros, from the assembler code, and translating the base macro code to code in the target language that corresponds to the assembler code.

### FIELD

The present invention relates in general to the field of computer programming. More particularly, the invention is related to a method and system for translating assembler code to a target language, such as COBOL, C, or C++.

### BACKGROUND

Computer programs can be made in many languages including high-level languages, such as C, Fortran, COBOL, etc., and low-level languages, such as assembler. Computer programs in high-level languages are typically easier to understand, code, and debug and often enjoy machine independence and portability. Thus, computer programs are increasingly coded in high-level languages rather than low-level languages, such as assembler. As a result, the computer programming resources are becoming increasingly scarce to support and maintain programs written in low-level languages. Moreover, since many deployed programs written in low-level languages are complex and of considerable size, rewriting them manually into a high-level language could be extremely costly in terms of expense and time. Therefore, a cost effective and quick way of converting low-level language programs into target high-level language programs, other than through manual rewriting, is desired.

### SUMMARY

In accordance with aspects of the invention, there is provided a method and computer program product for translating assembler language code into code in a target high level language. In an embodiment, the system and method process assembler language code by generating one or more predefined base macros corresponding to the assembler code. The base macros may then be translated to produce target language code corresponding to the original assembler language code.

In an embodiment, the method may receive as input an assembler language code listing. Each instruction in the assembler language code listing may be parsed to determine whether the instruction is a basic assembler language instruction, or a system or user macro. System and user macros may be expanded to their corresponding basic assembler language instruction. According to an embodiment of the invention, base macros may be included in the original assembler code listing. These base macros may not be expanded.

The method may generate and/or use one or more global tables. The tables may store data associated with the assembler code. For example, the global tables may store symbols, constants, data, procedures, and/or other information related to the assembler code. Further, the tables may store pseudo code generated based on the assembler code. The tables may also map one or more base macros to one or more corresponding assembler language instructions. Based on the global variable tables, the target language code may be generated. The method may generate corresponding base macro code for each assembler language instruction. The method may receive the base macro code as input and translate the base macro code to code in the desired target language.

### BRIEF DESCRIPTION OF THE DRAWINGS

The invention claimed and/or described herein is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a conventional system to generate target language code from assembler language code;

FIG. 2 illustrates a system to translate assembler language code into target language code, in accordance with an embodiment of the invention;

FIG. 3 illustrates an alternative system to translate assembler language code into target language code, in accordance with an embodiment of the invention;

FIG. 4 illustrates a process to generate target high level language source code, according to an embodiment of the invention;

FIG. 5 illustrates a method of processing assembler language instructions, according to an embodiment of the invention;

FIG. 6 illustrates a system to translate assembler language code into target language code, in accordance with an embodiment of the invention;

FIG. 7 illustrates a process to optimize and translate assembler language code into target language code, according to an embodiment of the invention;

FIG. 8 illustrates a process to generate pseudo code tables, according to an embodiment of the invention;

FIG. 9 depicts various pseudo code tables that may be generated, according to an embodiment of the invention;

FIG. 10 illustrates a system for refining pseudo code tables, according to an embodiment of the invention;

FIG. 11 illustrates a process to refine pseudo code table entries, according to an embodiment of the invention; and

FIG. 12 illustrates a system to generate target high level language source code, according to an embodiment of the invention.

### DETAILED DESCRIPTION

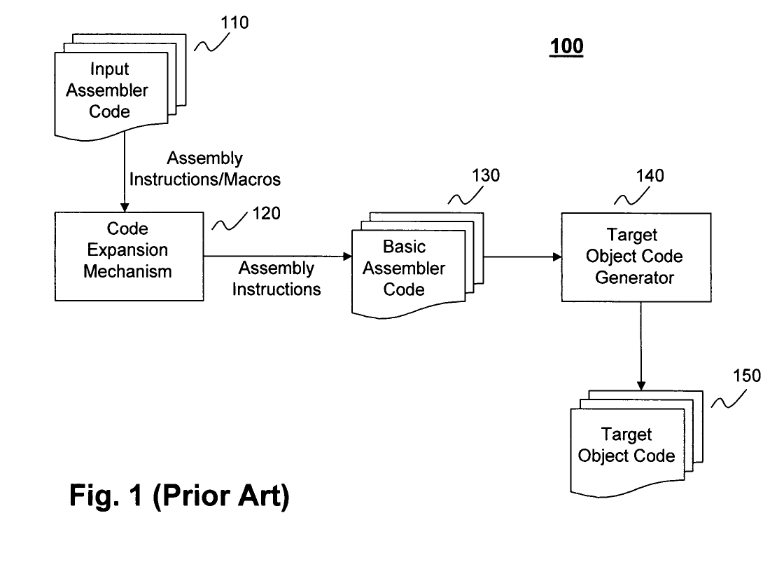

Referring to FIG. 1(a), a conventional system to generate target object code from assembler language code is schematically illustrated. As depicted at 110, assembler code is input into a code expansion mechanism 120. Code expansion mechanism 120 is used to expand the system and user macros of the input assembler code 110 into the corresponding assembler language instructions. The expanded macros and other instructions from the input assembler code 110 form the basic assembler code illustrated at 130. The basic assembler language code is processed by a target object code generator 140. The target object code generator 140 processes the basic assembler code 130, resulting in target object code 150.

An embodiment of the present invention expands the capability of conventional assembler language macro expansion systems by creating a correspondence between assembler language instructions and a plurality of predefined base macros. The base macros may include macros written to translate assembler code to code in a desired high level language. The desired target high level language may be, for example, COBOL, C, C++, Fortran, or other high level languages. The target high level language code may be in the form of source code.

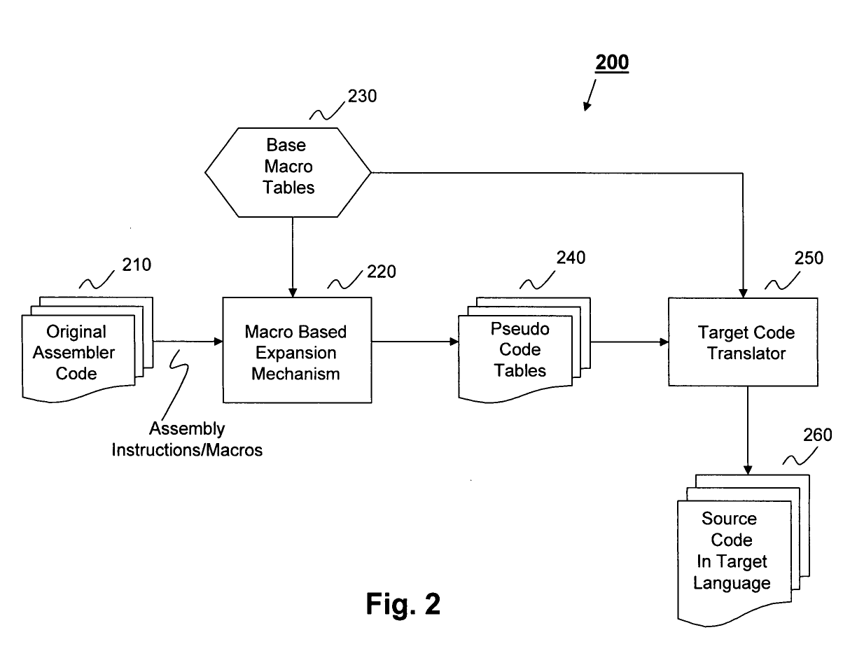

FIG. 2 illustrates a system 200 implementing an embodiment of the invention. System 200 includes an expansion mechanism 220 and a target code translator 250. As illustrated in FIG. 2, original assembler code 210 serves as input to macro based expansion mechanism 220. Original assembler code 210 may include assembler macros, such as user and system macros, as well as assembler code instructions. In an implementation, the user and system macros may be expanded to assembler language instructions using macro based expansion mechanism 220. Further, base macro tables 230 include one or more tables mapping assembler instructions and/or macros to corresponding base macros. Base macro tables 230 may also include one or more tables mapping base macros to instructions in the target language.

Macro based expansion mechanism 220 retrieves one or more base macros from one or more base macro tables 230 for each assembler instruction and/or macro. The retrieved one or more macros may include one or more macros written to cause a plurality of global pseudo code tables 240, and/or entries therein, to be generated representing the base macro and the arguments present in the assembler instructions and/or macros. For example, such retrieved one or more macros may cause a symbol table, a constant table, a data definition table, an external configuration definition table, an executable code table, and/or other tables, and/or entries therein, to be created. Pseudo code tables will be described in further detail hereinafter.

As depicted at 250, global pseudo code tables 240 may be processed by target code translator 250. Target code translator 250 may call one or more base macros from the base macro tables 230 to refine the global pseudo code tables 240. Target code translator 250 may then call one or more base macros from the base macro tables 230 to generate source code in the target language, as depicted at 260.

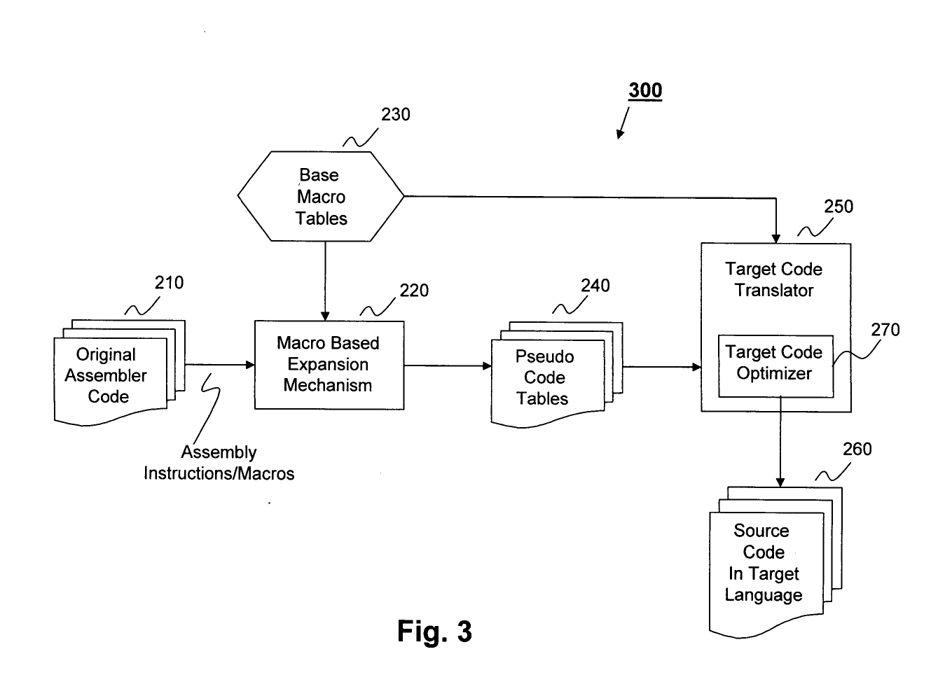

According to an embodiment of the invention, target code translator 250 may include a target code optimizer 270, as illustrated in FIG. 3. The target code optimizer 270 may comprise any past, present or future code optimization to, for example, improve the processing speed of the target code and/or to reduce the number of lines of code. Target code optimizer 270 may, for example, be a conventional compiler optimizer.

In an embodiment, all or part of the system 200 may be written in assembler to avoid language incompatibilities. For example, processing assembler code with a system written at least in part in assembler can avoid having to reformat parameters as may be required where assembler is processed by a system written in a language other than assembler and that uses different parameter formatting.

In an embodiment assembler to COBOL translator, the following example code:

CLC 0(3,2),=C′ABC′

BNE ERROR

could be processed as follows. A pseudo code generating base macro corresponding to the CLC assembler instruction (in this case, the CLC instruction performs a Compare Logical Characters with a first operand specifying offset 0 from the address in register 2 for a length of 3 characters, where the second operand references a 3 character literal assigned an address in storage by the assembler) generates a base macro CSS entry in an executable code table (as discussed in more detail below) and adds literal C′ABC′ to a literal table (as discussed in more detail below). A pseudo code generating base macro corresponding to BE generates a base macro BCX entry in the executable code table.

Then, a COBOL code generating base macro generates working storage literal field LIT1. A COBOL code generating base macro calls the CSS base macro (the Compare Storage to Storage (CSS) base macro is used to map several different assembler instructions, such as CLC, CLI, and/or LCLC, into a language neutral macro pseudo code table format which can then later be used to generate code in the target language) which checks for a BCX base macro following the CSS base macro and changes the BCX base macro in the executable code table to an IFX base macro to generate IF THEN instead of code to set condition code and then test condition code. A COBOL code generating base macro then calls the IFX base macro to generate IF THEN GO TO code. The first CLC instruction parameter 0(3,2) stored in the executable code table would be used to generate SET instructions to address the specified offset from the register pointing to working storage. The second CLC instruction argument=C‘ABC’ is looked up in the literal table to get the working storage reference label WS-LIT1. The BE (Branch if condition code Equal) instruction label ERROR stored in the executable code table is looked up in a symbol table (as discussed in more detail below) to verify that PG-ERROR is a valid code section or block label.

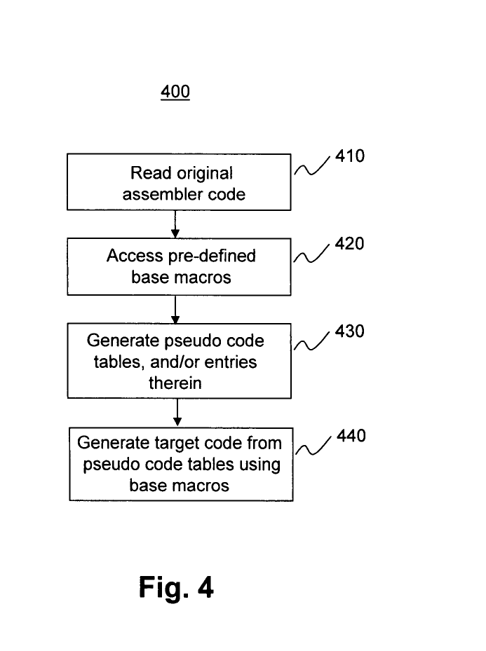

FIG. 4 illustrates a process 400 for implementing an embodiment of the invention. As depicted at 410, original assembler code is input into the system and read by a processing mechanism such as a code expansion mechanism. The original assembler code may include assembler instructions, assembler macros (such as user macros and/or system macros), and/or other assembler code. In an embodiment, the original assembler code may also include base macros. In an embodiment, reading the original assembler code may include expanding any user or system macros into corresponding assembler language instructions.

Pre-defined base macros are used in the conversion of assembler language code to target language code, as depicted at 420. Assembler language instructions and/or macros 410 correspond to one or more pre-defined base macros. Corresponding base macros for the assembler language instructions and/or macros are used to cause one or more pseudo code tables, and/or entries therein, to be generated, as depicted at 430. The generated pseudo code tables and/or entries therein will be described in greater detail hereinafter. One or more base macros may also correspond to one or more instructions in the target language code. As depicted at 440, the generated pseudo code tables and the base macros are used to generate code in the target language.

In an example assembler to COBOL translator, for each assembler instruction there may be multiple COBOL verbs generated. For example, the assembler RX type add instructions A, AR, AG, and AGR may map to a base macro which may generate the following COBOL verbs depending on context: SET (used to set storage pointer for field being added to register), ON EXCEPTION (used to handle overflow if required), ADD (used to do the actual add function between fields), IF THEN ELSE (used to generate conditional logic to set condition code if needed when multiple branch instructions follow), or MOVE (used to set condition code if required).

Some additional examples of assembler instructions and macros, there corresponding code generation base macros and the COBOL verbs generated include:

BC—branch on condition has a base macro to generate code using the verbs MOVE, IF, and GOTO in order to test condition code and branch if required

TRT—translate and test has a base macro to generate code using the verbs SET, MOVE, PERFORM, IF, and ADD

WTO—write to operator has a base macro to generate either a DISPLAY verb or a CALL to a runtime module if register notation is used to pass the address of the target message to be displayed

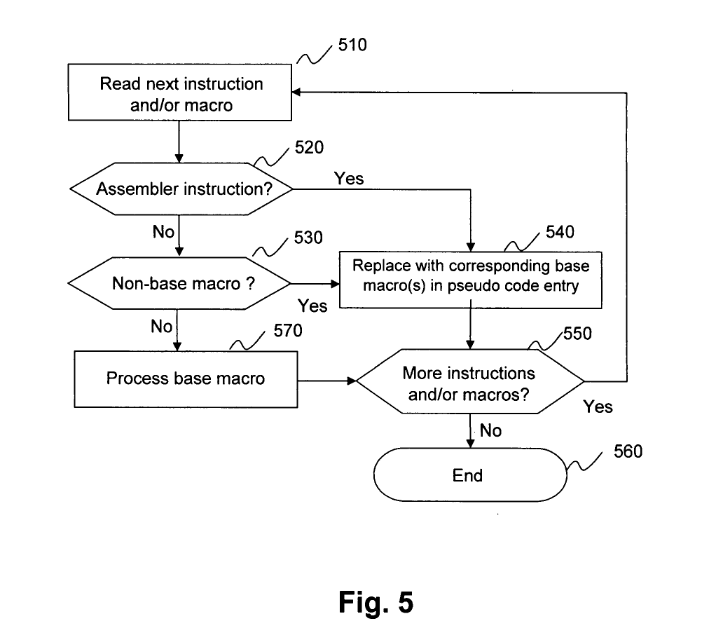

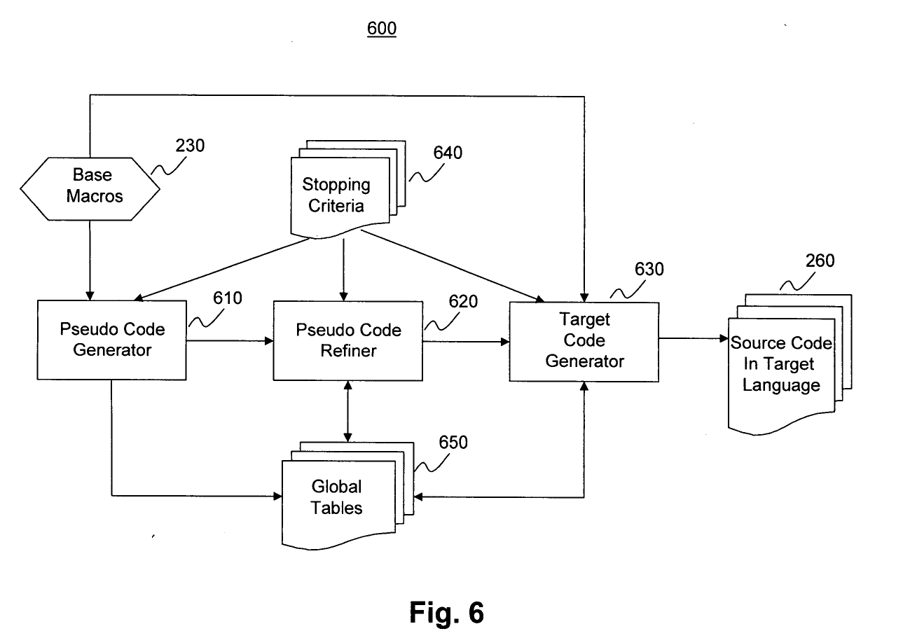

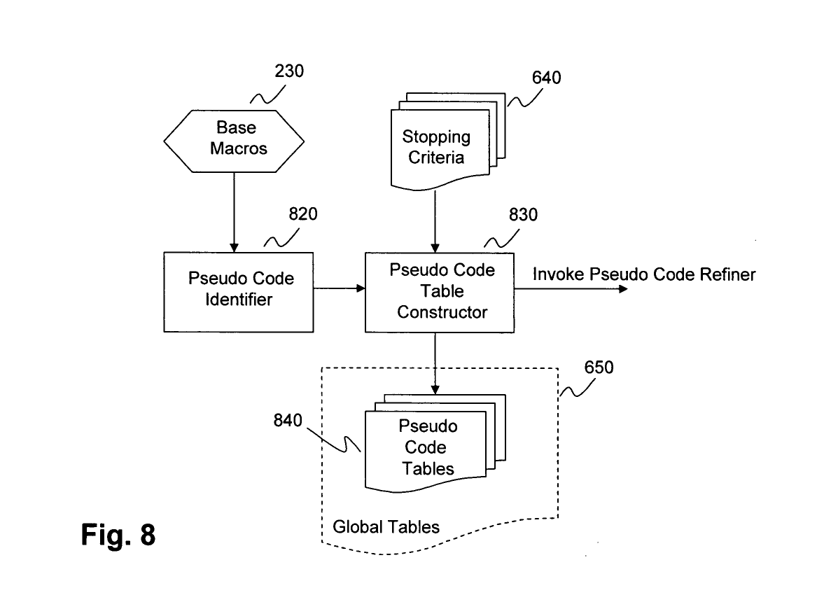

FIG. 5 illustrates a procedure to process assembler language source code according to an embodiment of the invention. As depicted at 510, each instruction and/or macro of the assembler language source code may be read by a code expansion mechanism. As illustrated at 520, a determination is made as to whether the instruction and/or macro read is an assembler instruction. Assembler instructions may correspond to one or more base macros, the definitions of which may be stored in one or more base macro tables. As depicted at 540, for an assembler instruction, a pseudo code entry is created, replacing the assembler instruction with the corresponding base macro(s). Pseudo code generation is discussed in more detail below, for example, in reference to FIGS. 6 and 8. A check may be performed thereafter to determine whether there are additional instructions and/or macros for processing, as illustrated at 550. In an embodiment, all non-base macros may be expanded in which case the determination depicted at 530, and discussed below, is not required.

If the instruction and/or macro read is not an assembler instruction, a determination is made as to whether it is a non-base macro, as depicted at 530. Non-base macros include macros other than base macros, such as assembler macros. In an embodiment, various non-base macros, such as certain assembler user and system macros, correspond to one or more base macros, the definitions of which may be stored in one or more base macro tables. If it is determined that the instruction and/or macro read is a non-base macro, a pseudo code entry is created for the assembler macro, as depicted at 540, replacing the assembler macro with the corresponding base macro(s). However, in an embodiment, an assembler macro may be expanded into one or more corresponding assembler instructions and for those assembler instructions one or more corresponding pseudo code entries may be created at 540, whether directly or after later processing at 520. After processing the non-base macros (if any), a determination may be made as to whether there are additional instructions and/or macros, as illustrated at 550.

According to an embodiment, an assembler language code listing may include one or more base macros. For example, some assembler code listings may be large in size. These listings may warrant optimizing by defining base macros that map directly to target language instructions, rather than coding in numerous assembler instructions and/or macros. In addition or alternatively, certain assembler instructions and/or macros may yield large or less than optimal target language code, particularly in nesting situations, which may be overcome by defining a base macro to map certain assembler instructions and/or macros into target language instructions. If the instruction and/or macro read is a base macro, the base macro may simply be processed as an entry into the pseudo code tables, as depicted at 570. Thereafter, a check may be performed to determine whether there are additional instructions and/or macros for processing, as illustrated at 550.

In an embodiment, checking 550 may comprise determining if the END macro of the assembler code has been reached.

If there are no additional instructions and/or macros to be processed, the process ends at 560 and then proceeds to pseudo code refinement and target language code generation from the pseudo code. Pseudo code refinement and target language code generation is discussed in more detail below, for example, in reference to FIGS. 6 to 12.

A system 600 to translate assembler language code into target language code is illustrated in FIG. 6, in accordance with an embodiment of the invention. The system includes a pseudo code generator 610, a pseudo code refiner 620, and a target code generator 630. As described above in reference to FIG. 2, assembler language code may be received and/or expanded to basic assembler language instructions. Based on the assembler language instructions, one or more base macros may cause one or more pseudo code tables to be generated.

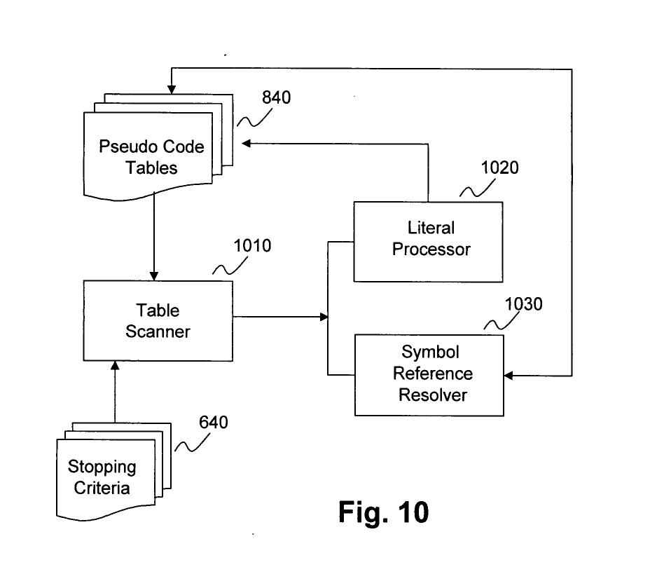

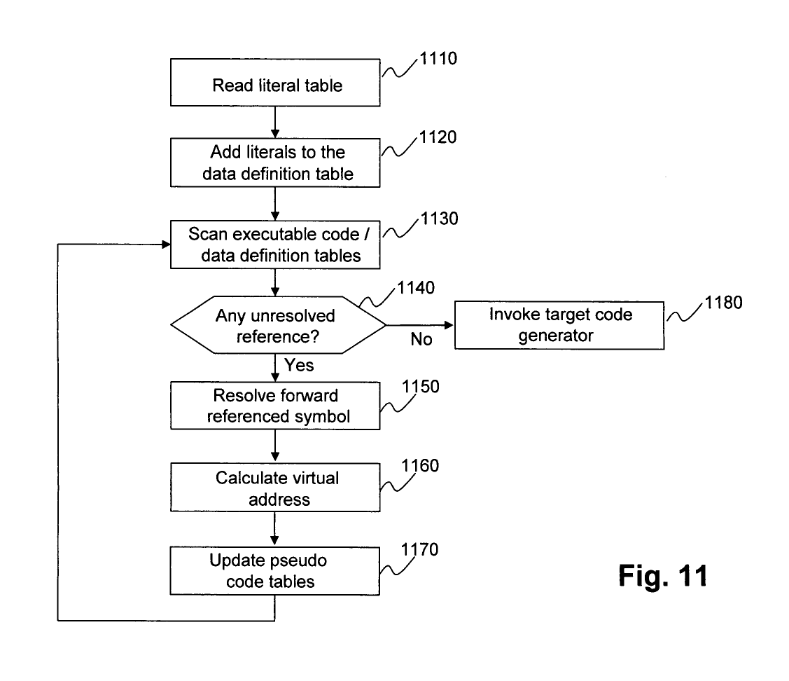

In an embodiment, a pseudo code generator 610 is provided to create one or more pseudo code tables of the global tables 650 based on received assembler language instructions. Pseudo code generator 610 may call one or more pseudo code generation macros from the base macros 230. The called pseudo code generation macros are determined based on the assembler language instruction. Pseudo code generation is described in more detail below with respect to FIG. 8. After each instruction has been processed (a stopping criteria 640) and pseudo code is generated, pseudo code refiner 620 may be used to refine the pseudo code tables. Pseudo code refiner 620 may update one or more pseudo code tables. Pseudo code refinement is discussed in more detail below with respect to FIGS. 10 and 11.

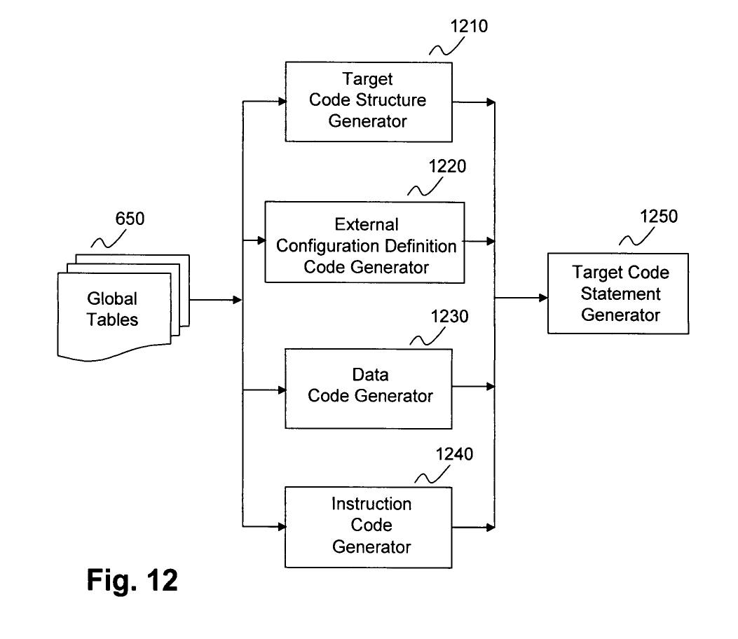

Once the pseudo code tables have been generated and/or refined (a further stopping criteria 640), target code generator 630 translates the pseudo code to source code in the target language, as depicted at 260. Target code generator 630 may call one or more code generation macros from the base macros 230. The code generation macros cause target code generator 630 to create one or more target language code sections, and to fill each section with the appropriate target language code, resulting in source code in the target language, as depicted at 260. Target code generator 630 finishes when the pseudo code has been translated into source code (another stopping criteria 640). Target code generation is discussed in more detail below with respect to FIG. 12.

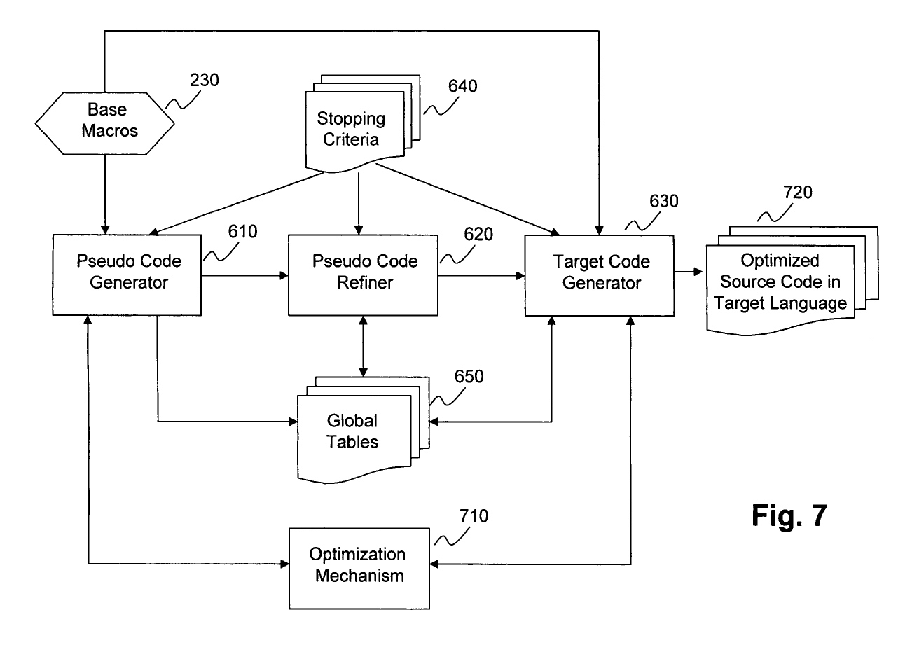

According to an embodiment of the invention, an optimization mechanism 710 may be provided, as illustrated in FIG. 7. Assembler instructions and macros sometimes may generate several lines of code in the target language, some of which may be unnecessary. Optimization mechanism 710 may call one or more optimization macros to provide optimized target code 720.

For example, nested macros may be replaced with modified macros to generate pseudo code entries. In another or alternative example, generation of code to set a linkage section pointer may be suppressed if the pointer has already been set within the same code section or block and has not been changed. In another or alternative example, generation of code to set a condition code indicating the result of a current instruction may be suppressed if no conditional branch follows. In another or alternative example, code to set and then test a condition code may be replaced with more efficient high level language ‘if then’ code to test the result of the last instruction and go to a branch label if the test is true. In another or alternative example, generated branch indirect code may be replaced with more efficient high level language CALL or PERFORM code if there is a matching single branch register return and if there are no conditional branch register exits from the performed code. In another or alternative example, generation of code to load and store registers (L, LM, ST, and STM) at entry and exit may be suppressed during pseudo code generation. In another or alternative example, generation of go to next instructions may be suppressed if the target label is the next instruction. In another or alternative example, generation of code to set pointer to working storage areas may be suppressed so that only code for linkage section data areas is generated. In another or alternative example, generation of branch indirect code may be suppressed if there are no branch register instruction references.

While the above optimizations are catered more to generation of code in COBOL as the target language, those skilled in the art will appreciate that similar optimizations may be applied for other target languages and that other, different optimizations may be implemented, whether generic to all target language or specific to certain target languages.

Referring now to FIG. 8, the pseudo code generation process is illustrated in further detail. For each instruction and/or macro received, a pseudo code identifier 820 determines the type of pseudo code entry to be created. A determination may be made as to whether the instruction and/or macro, for example relative to COBOL, is a procedural instruction, contains symbols or literals, defines the environment in which the program is to be run, etc. For example, an assembler instruction such as “CLC 0(3,2)=C′ABC′” creates an entry in an executable code table describing the procedure to be performed. An entry is also made in a literal table for the literal C′ABC′.

Based on the type of instruction and/or macro, one or more appropriate base macros 230 are called to create the appropriate pseudo code entries. A base macro 230 may map to one or more assembler instructions and/or macros. For example, a base macro corresponding to an add operation may map to a plurality of assembler add instructions and/or macros. As another example, a base macro may be able to handle different length options of an assembler instruction and/or macro, such as 32 bit or 64 bit operands, by adding a base macro operand indicating the size option. Depending on the context in which the assembler instruction and/or macro is used, one or more target language instructions may be created based on the base macro. Pseudo code table constructor 830 creates and populates one or more pseudo code tables 840.

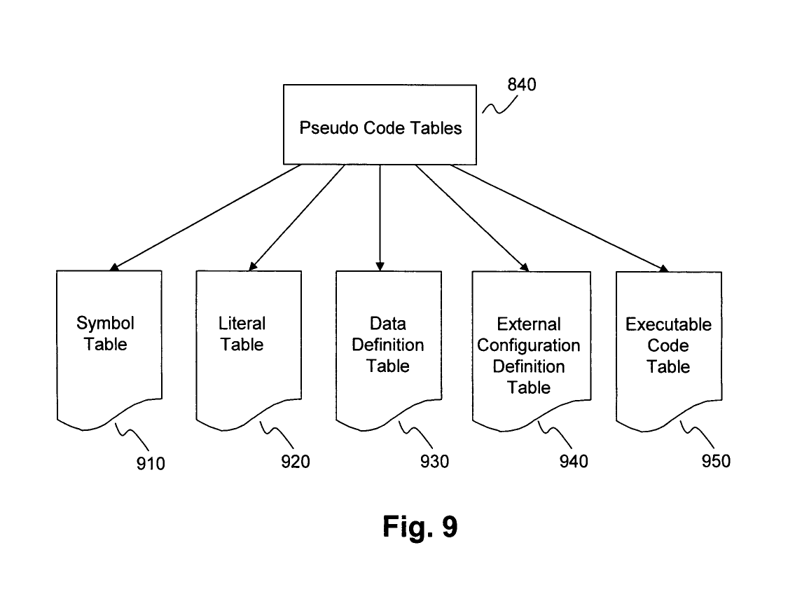

As illustrated in FIG. 9, pseudo code tables 840 may include, for example, a symbol table 910, a literal table 920, a data definition table 930, an external configuration definition table 940, an executable code table 950, and/or other tables.

Symbol table 910 is used to store statement labels from the assembler language code along with an assigned relocatable address or absolute value and a corresponding target language data name. Symbol table 910 may be used by the pseudo code generator, the pseudo code refiner, and/or the target code generator. The pseudo code generator may cause symbols to be added when processing instructions, the pseudo code refiner may cause symbols to be updated, and the target code generator may obtain target language names and values to be used in generating the target language program. Symbol table 910 may define the symbol name, the symbol value, the symbol class, and/or other symbol information. The base macros to generate the target language code may query the symbol table to determine if target language should be generated. For example, a statement label may define the end of a data section or be the target of a branch to assembler instruction. By examining both the symbol table entry and the context in which the symbol is generated, appropriate target language code can be generated. For example, a single assembler EQU * type symbol may result in both a data division label and a procedure division label being generated based on multiple references to data and to instructions via the same symbol.

Literal table 920 is used to store operand literals. The literals may be added by the pseudo code generator and may be placed at the end of the data definition area by the target code generator. When the target source code is being generated, literal references may be replaced with their generated target language data names in the data definition table.

Data definition table 930 (e.g., a working storage table for a COBOL application) is used to describe general variables used in the program and the values assigned to the variables. In an embodiment, the data definition table also comprises linkage section data definitions. Data definition table 930 may also define program elements such as register work areas, switches, counters, accumulators, and/or other program elements. In an embodiment, pseudo code that corresponds to assembler DS, DC, and EQU instructions are added to the data definition table 930.

External configuration definition table 940 is used to store information related to the external configuration (e.g., environment) in which the target language code will run. Aspects of a program are sometimes dependent upon specific computer hardware or software operating system, device, or encoding type. External configuration definition table 940 may store this information. Stored information may include, for example, environment variables, parameters, and/or other external configuration definition information. In an embodiment, file information pseudo code to define files that correspond to assembler DCB (Data Control Block for IBM OS operating system file) and DCBE instructions are added to the external configuration definition table 940.

Executable code table 950 is used to store pseudo code describing the manipulation of program data. The instructions required to execute the program may be stored as pseudo code in executable code table 950. Executable code table 950 is used to generate the target language code.

Some additional possible tables include:
an alter table to store a generated name of a working storage field used to test if alter byte is set to indicate assembler instructions, such as a NOP branch (No Operation), have been modified by assembler code. New alter instruction entries are added during pseudo code generation, alter fields are generated in the data definition table during target language code generation, and references to alter fields generated during executable code generation for each altered NOP instruction.
a branch relative indirect table to store procedure labels and external labels and their associated index values. Entries are added during pseudo code and target language generation and indirect branch code is generated at end of procedure division code for use by branch register generated code.
a target language data table to store references to external data tables. A corresponding code generator adds, deletes, generates, and initializes target language data table entries. Data access to external address constants are added as target language data table references (external CSECTS). Programs with no instructions are automatically generated as target language data tables which can be compiled into executable program format and then be automatically loaded and accessed by other programs referencing them via external address constants.
a pointer table to optimize code generation for setting linkage section pointers. Instructions which update registers update the pointer table for use in generating linkage section set statements during target language code generation. If the register has already been set within the current code section or block, then no code is generated. The pointer table is also used to detect if a register pointer is set to a target language data table versus an external program.
a working storage multiple field table for DS and DC data statements, the table populated with one or more fields including duplication count, type, length, multiple values, and relocation data.
a relocation table to store addresses requiring relocation to absolute address during initialization. Relocation calculations are saved in the table and the table facilitates generation of initialization code for relocatable address constants when called during target language code generation. Relocatable address expressions are optimized and then added to the working storage multiple field table for a current DC statement with one or more relocatable address fields. Working storage multiple field table temporary relocatable data is added to the relocation table for use by target language code initialization code generation during target language code generation.

Referring now to FIG. 10, the process of refining the generated pseudo code tables is described in further detail. As depicted at 840, the generated pseudo code tables may be input to table scanner 1010. Table scanner 1010 may scan each table, determining which tables and which pseudo code entries may be refined. As depicted at 1020, refining may include generating literals at the end of the data definition table by reading literal table 920 and/or adding data definition pseudo code to data definition table 930. This refining may be performed by calling one or more macros to perform those one or more functions.

As depicted at 1030, the pseudo code refining process may include resolving symbol references. One or more macros may be called to update data definition and procedure code section or block labels in symbol table 910 based upon the resolved reference. This process may be repeated until all forward references are resolved, e.g., until there are no errors due to nested forward references or the number of such errors remains constant, and recalculating virtual addresses. For example, resolving the reference may comprise identifying a reference present in the table, calculating an address for a data reference in the data definition table, or an instruction reference in the executable code table, or both, or associating the calculated address with the identified reference. The reference may be identified from the executable code table and is a virtual address calculated based on the data definition table. Thus, separate data and instruction references may be generated from the same assembler symbol. Additionally or alternatively, working storage fields may addressed by label, by register offset, or both.

The process of refining generated pseudo code tables is described in further detail in FIG. 11. As depicted at 1110, a literal table may be read and the literals may be added to the data definition table, as depicted at 1120. As described above, the literal table may store operand literals as assembler instructions are processed. The literals are assigned labels and generated at the end of the data definition table so they can be referenced in generated code.

As depicted at 1130 and 1140, the executable code and data definition tables are scanned to determine whether there are unresolved symbol references. If all symbols have been resolved, the target code generator may be invoked, as depicted at 1180.

As depicted at 1150, forward references may be resolved by, for example, following the executable code table and consulting the data definition table to resolve the forward referenced variables or literals. The virtual address associated with the resolved symbol is calculated, as depicted at 1160, and pseudo code tables are updated to reflect the symbol resolutions, as depicted at 1170.

Once the pseudo code tables have been generated and/or refined, a target code generator may be invoked to generate code in the desired target language. FIG. 12 illustrates a target code generator in further detail. The target code generator may include a target code structure generator 1210, an external configuration definition code generator 1220, a data code generator 1230, and an instruction code generator 1240. Other code section generators may be provided, as needed.

As depicted at 650, global tables, including one or more pseudo code tables, may be input to the target code generator. Target code structure generator 1210 may be invoked to generate the overall structure of the target language code. For example, COBOL programs typically have an environment section, a data section, and a procedure section. Other target language programs may have the same or other sections. These sections may be generated by target code structure generator 1210. Optionally, target code structure generator 1210 generates code for the identification division of a program in a target language such as COBOL, the code including a program identification/name obtained from, for example, a CSECT name.

External configuration definition code generator 1220 generates code for the environment division. External configuration definition code generator 1220 may process each entry in the external configuration definition table and generate the corresponding code. For example, an assembler program with a DCB instruction may generate entries in the external configuration definition table with information to generate the environment division code and the external configuration definition code generator 1220 may generate, for example, file definitions for each DCB defined.

Data code generator 1230 causes data division code, such as working storage and linkage section data structures, to be created by processing entries in one or more tables, such as the literal and data definition tables. Instruction code generator 1240 generates executable code (e.g., procedure division code in a COBOL application) by processing each entry in the executable code table. In an embodiment, instruction code generator 1240 may perform operating system functions such as obtaining time and date, memory, etc. There is also code optimization code to detect if the assembler program is receiving parameters passed to it, and if so target code is generated to defining optional linkage section and associated set statements to link variables with parameters passed.

In an embodiment, the output of the generators 1210-1240 is input into target code statement generator 1250 to generate and/or form the code in the target language.

In an embodiment, the system allows base macros to be generated and/or customized by the user. In this way, for example, the user can prepare base macros for new user assembler macros, customize the target language generated by a base macro, and/or optimizing the code generated by defining base macros that map user macros directly to target language verbs rather than using the default expansion of macros to basic assembler instructions and then translating the basic assembler instructions to target language verbs.

The detailed description herein may have been presented in terms of program procedures executed on a computer or network of computers. These procedural descriptions and representations are the means used by those skilled in the art to most effectively convey the substance of their work to others skilled in the art. One or more embodiments of the invention may be implemented as apparent to those skilled in the art in hardware or software, or any combination thereof. The actual software code or specialized hardware used to implement an embodiment of the invention is not limiting of the present invention. Thus, the operation and behavior of one or more embodiments often will be described without specific reference to the actual software code or specialized hardware components. The absence of such specific references is feasible because it is clearly understood that artisans of ordinary skill would be able to design software and hardware to implement the one or more embodiments of the present invention based on the description herein with only a reasonable effort and without undue experimentation.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein; the operations are machine operations. Useful machines for performing the operations described herein may include general purpose digital computers or similar devices.

Each step of the method may be executed on any general computer, such as a mainframe computer, personal computer or the like and pursuant to one or more, or a part of one or more, program modules or objects generated from any programming language, such as C++, Java, Fortran or the like. And still further, each step, or a file or object or the like implementing each step, may be executed by special purpose hardware or a circuit module designed for that purpose. For example, an embodiment of the invention may be implemented as a firmware program loaded into non-volatile storage or a software program loaded from or into a data storage medium as machine-readable code, such code being instructions executable by an array of logic elements such as a microprocessor or other digital signal processing unit.

In the case of diagrams depicted herein, they are provided by way of example. There may be variations to these diagrams or the steps (or operations) described herein without departing from the spirit of the invention. For instance, in certain cases, the steps may be performed in differing order, or steps may be added, deleted or modified. All of these variations are considered to comprise part of the invention as recited in the appended claims.

While the description herein may refer to interactions with the user interface by way of, for example, computer mouse operation, it will be understood that the user may be provided with the ability to interact with these graphical representations by any known computer interface mechanisms, including without limitation pointing devices such as a computer mouse or a trackball, a joystick, a touch screen or a light pen implementation or by voice recognition interaction with the computer system.

While an embodiment has been described in relation to a particular high-level language, an embodiment need not be solely implemented using that high-level language. It will be apparent to those skilled in the art that an embodiment of the invention may equally be implemented in other computer languages, such another object oriented language or assembly or machine language.

An embodiment of the invention may be implemented as an article of manufacture comprising a computer usable medium having computer readable program code means therein for executing the method steps of an embodiment of the invention, a program storage device readable by a machine, tangibly embodying a program of instructions executable by a machine to perform the method steps of an embodiment of the invention, or a computer program product. Such an article of manufacture, program storage device or computer program product may include, but is not limited to, CD-ROMs, diskettes, tapes, hard drives, computer system memory (e.g. RAM or ROM) and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, magnetic or optical, or the like, for storing or transmitting signals readable by a machine for controlling the operation of a general or special purpose computer according to the method of an embodiment of invention and/or to structure its components in accordance with a system of an embodiment of the invention.

An embodiment of the invention may be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such a cellular telephone).

The system may be specially constructed for the required purposes to perform, for example, the method steps of the an embodiment of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. One or more embodiments of the invention presented herein are not inherently related to a particular computer system or other apparatus. The required structure for a variety of these systems will appear from the description given.

While this invention has been described in relation to one or more embodiments, it will be understood by those skilled in the art that other embodiments according to the generic principles disclosed herein, modifications to the disclosed embodiments and changes in the details of construction, arrangement of parts, compositions, processes, structures and materials selection all may be made without departing from the spirit and scope of the invention. Many modifications and variations are possible in light of the above teaching. Thus, it should be understood that the above described embodiments have been provided by way of example rather than as a limitation of the invention and that the specification and drawing(s) are, accordingly, to be regarded in an illustrative rather than a restrictive sense. As such, the present invention is not intended to be limited to the embodiments shown above but rather can be embodied in a wide variety of forms, some of which may be quite different from those of the disclosed embodiments, and extends to all equivalent structures, acts, and, materials, such as are within the scope of the appended claims. The present invention as defined by the appended claims is to be accorded the widest scope consistent with the principles and novel features disclosed in any fashion herein.

1. A method for translating assembler code to target high level language source code, comprising:
generating base macro code, based on a plurality of base macros, from the assembler code; and
translating the base macro code to code in the target language that corresponds to the assembler code.

2. The method of claim 1, wherein a base macro of the plurality of base macros corresponds to a statement in the target language.

3. The method of claim 1, wherein a base macro of the plurality of base macros corresponds to a system assembler macro, a user-defined assembler macro, and/or an assembler instruction of the assembler code.

4. The method of claim 1, wherein generating the base macro code comprises:
reading an instruction or macro in the assembler code;
determining whether the instruction or macro read corresponds to a base macro of the plurality of base macros;
generating base macro code based on the base macro that corresponds to the instruction or macro read; and
repeating the reading, determining, and generating until all instructions in the assembler code have corresponding base macro code.

5. The method of claim 4, wherein generating the base macro code further comprises, if the instruction or macro read is an assembler macro that is not a base macro, replacing the instruction or macro read with one or more instructions that define the read assembler macro.

6. The method of claim 1, wherein translating the base macro code comprises constructing a global table corresponding to the base macro code.

7. The method of claim 6, wherein the global table comprises:
a symbol table configured to store a symbol from the assembler code;
a literal table configured to store an operand literal specified in the assembler code;
a data definition table configured to store information related to data associated with the assembler code;
an external configuration definition table configured to store information related to an operational external configuration of the assembler code; and/or
an executable code table configured to store information related to executable instructions in the assembler code.

8. The method of claim 7, wherein constructing the global table comprises:
reading an instruction from the assembler code;
adding an entry to the global table by:
adding a label to the symbol table if the instruction or macro read has a label that is not in the symbol table,
adding a literal to the literal table if the instruction or macro read involves a literal that is not in the constant table,
adding a data definition pseudo code to the data definition table for data involved in the instruction or macro read,
adding a file information pseudo code to the external configuration definition table for a file involved in the instruction or macro read, and/or
adding an executable pseudo code to the executable code table if the instruction or macro read corresponds to an executable instruction; and
repeating the reading an instruction and adding an entry until the instruction or macro read indicates an end of the assembler code.

9. The method of claim 6, wherein translating the base macro code further comprises:
refining the global table to produce a refined global table; and
generating the code in the target language based on the refined global table.

10. The method of claim 9, wherein refining the global table comprises:
scanning the global table;
resolving a reference occurring in the global table to produce a resolved reference;
updating the global table based on the resolved reference; and
repeating the scanning and resolving until no more reference can be resolved.

11. The method of claim 10, wherein resolving the reference comprises:
identifying a reference present in the global table;
calculating an address for a data reference in the data definition table, or an instruction reference in the executable code table, or both; and
associating the calculated address with the identified reference.

12. The method of claim 11, wherein the reference is identified from the executable code table and is a virtual address calculated based on the data definition table.

13. The method of claim 7, wherein translating the base macro code comprises:
generating an overall structure of the code in the target language;
generating a first portion of the code in the target language defining an operational external configuration of the code based on the external configuration definition table;
generating a second portion of the code in the target language defining data to be used by the code based on the data definition table; and
generating a third portion of the code in the target language defining operations to be performed by the code in the target language during execution based on the executable code table.

14. The method of claim 1, wherein the target language is COBOL.

15. A computer program product readable by a machine, tangibly embodying a program of instructions executable by a machine to perform a method of translating assembler code to target high level language source code, the computer program product comprising:
program instructions embodying a base macro configured to generate base macro code, based on a plurality of base macros, from the assembler code; and
program instructions embodying a base macro configured to translate the base macro code to code in the target language that corresponds to the assembler code.

16. The computer program product of claim 15, wherein a base macro of the plurality of base macros corresponds to a statement in the target language.

17. The computer program product of claim 15, wherein a base macro of the plurality of base macros corresponds to a system assembler macro, a user-defined assembler macro, and/or an assembler instruction of the assembler code.

18. The computer program product of claim 15, wherein the program instructions embodying the base macro configured to generate the base macro code comprises:
program instructions embodying a base macro configured to read an instruction or macro in the assembler code;
program instructions embodying a base macro configured to determine whether the instruction or macro read corresponds to a base macro of the plurality of base macros;
program instructions embodying a base macro configured to generate base macro code based on the base macro that corresponds to the instruction or macro read; and
program instructions embodying a base macro configured to repeat the reading, determining, and generating until all instructions in the assembler code have corresponding base macro code.

19. The computer program product of claim 18, wherein the program instructions embodying the base macro configured to generate the base macro code further comprises program instructions embodying a base macro configured to, if the instruction or macro read is an assembler macro that is not a base macro, replace the instruction or macro read with one or more instructions that define the read assembler macro.

20. The computer program product of claim 15, wherein the program instructions embodying the base macro configured to translate the base macro code comprises program instructions embodying a base macro configured to construct a global table corresponding to the base macro code.

21. The computer program product of claim 20, wherein the global table comprises:
a symbol table configured to store a symbol from the assembler code;
a literal table configured to store an operand literal specified in the assembler code;
a data definition table configured to store information related to data associated with the assembler code;
an external configuration definition table configured to store information related to an operational external configuration of the assembler code; and/or
an executable code table configured to store information related to executable instructions in the assembler code.

22. The computer program product of claim 21, wherein the program instructions embodying the base macro configured to construct the global table comprises:
program instructions embodying a base macro configured to read an instruction from the assembler code;
program instructions embodying a base macro configured to add an entry to the global table by:
adding a label to the symbol table if the instruction or macro read has a label that is not in the symbol table,
adding a literal to the literal table if the instruction or macro read involves a literal that is not in the constant table,
adding a data definition pseudo code to the data definition table for data involved in the instruction or macro read,
adding a file information pseudo code to the external configuration definition table for a file involved in the instruction or macro read, and/or
adding an executable pseudo code to the executable code table if the instruction or macro read corresponds to an executable instruction; and
program instructions embodying a base macro configured to repeat the reading an instruction and adding an entry until the instruction or macro read indicates an end of the assembler code.

23. The computer program product of claim 20, wherein the program instructions embodying the base macro configured to translate the base macro code further comprises:
program instructions embodying a base macro configured to refine the global table to produce a refined global table; and
program instructions embodying a base macro configured to generate the code in the target language based on the refined global table.

24. The computer program product of claim 23, wherein the program instructions embodying the base macro configured to refine the global table comprises:
program instructions embodying a base macro configured to scan the global table;
program instructions embodying a base macro configured to resolve a reference occurring in the global table to produce a resolved reference;
program instructions embodying a base macro configured to update the global table based on the resolved reference; and
program instructions embodying a base macro configured to repeat the scanning and resolving until no more reference can be resolved.

25. The computer program product of claim 24, wherein the program instructions embodying the base macro configured to resolve the reference comprises:
program instructions embodying a base macro configured to identify a reference present in the global table;
program instructions embodying a base macro configured to calculate an address for a data reference in the data definition table, or an instruction reference in the executable code table, or both; and
program instructions embodying a base macro configured to associate the calculated address with the identified reference.

26. The computer program product of claim 25, wherein the reference is identified from the executable code table and is a virtual address calculated based on the data definition table.

27. The computer program product of claim 21, wherein the program instructions embodying the base macro configured to translate the base macro code comprises:
program instructions embodying a base macro configured to generate an overall structure of the code in the target language;
program instructions embodying a base macro configured to generate a portion of the code in the target language defining an operational external configuration of the code based on the external configuration definition table;
program instructions embodying a base macro configured to generate a portion of the code in the target language defining data to be used by the code based on the data definition table; and
program instructions embodying a base macro configured to generate a portion of the code in the target language defining operations to be performed by the code in the target language during execution based on the executable code table.

28. The computer program product of claim 15, wherein the target language is COBOL.
